(19) United States
(12) Patent Application Publication
(10) Pub. No.: US 2020/0210693 A1
(43) Pub. Date: Jul. 2, 2020

(54) INTERNET-BASED CROWD PEER REVIEW METHODS AND SYSTEMS

(71) Applicant: GEORG THIEME VERLAG KG, Stuttgart (DE)

(72) Inventors: Brian Scanlan, Wycoff, NJ (US); Daniel Schiff, Paris (FR)

(21) Appl. No.: 16/233,291

(22) Filed: Dec. 27, 2018

(51) Int. Cl. G06K 9/00; G06Q 10/06; G06Q 10/10; G09B 7/04; G06F 17/24; G06F 21/62

(52) U.S. Cl. CPC G06K 9/00442; G06Q 10/063; G06Q 10/107; H04L 51/32; G06F 17/241; G06F 21/6209; G09B 7/04

(57) ABSTRACT

An internet-based crowd peer review method employing a user interface in communication through the internet with a peer review application and in which proposed documents are made available to a large group of pre-approved reviewers for simultaneous and rapid peer review and comment. The internet-based crowd peer review method significantly shortens the time for performance and completion of a peer review of a proposed document by imposing, for each proposed document under review, one or more of the following limits or criteria: a maximum time period for accepting reviews of from about 3 days to about 60 days, a minimum quantity of reviewers, a maximum quantity of reviewers, a minimum or maximum quantity of reviewers allowed submit reviewer comments, a maximum time period for accepting revised documents from authors, as well as other factors and criteria set forth herein. One or more of the foregoing limits or criteria may be imposed simultaneously.

### FIELD OF THE INVENTION

The present invention relates generally to internet-based crowd peer review methods. More particularly, the present invention relates to internet-based methods for facilitating peer review of documents and other authored works such as technical articles, reports, studies, grant proposals, and video performances, which are reviewed by pre-authorized reviewers and which may be revised by the authors based on such reviews prior to publication or acceptance.

### BACKGROUND OF THE INVENTION

Peer review is a method used by scientific, medical, legal and other journals, as well as universities, government agencies, and non-profit organizations, among others, to review and evaluate the credibility and scientific or professional value of documents submitted, for example, for publication in a professional journal, or as a grant proposal. Peer review is also used as a means for feedback which provides the basis for revision and improvement of such documents. Peer review of a document has traditionally been performed by qualified reviewers having expertise in the relevant field. Several (i.e., 2-4) reviewers are typically selected and assigned to assess a single document to mitigate bias or prejudice which may influence the opinion of a single reviewer. However, it can be difficult to minimize or eliminate bias and prejudice because a human often remains involved in the selection and distribution of documents and the selection of reviewers for each document, it can be difficult to introduce or increase randomness, anonymity, or both, to conventional peer review processes. Reviewers analyze the documents for strengths and weaknesses, and typically provide a written review, either as comments and edits within the document or as a separate statement, commentary or recommendation with respect to publication or funding, as well as suggestions for improvement.

For various reasons related to the nature of conventional peer review processes, current peer review processes are often unnecessarily time-consuming for journal editors and reviewers or take too long from the perspective of the journal editors or grant decision makers. For example, to establish a group of preselected qualified reviewers assigned to review each document, an editor typically contacts several potential reviewers and waits for each to confirm his or her agreement to review a particular document. If only one or two reviewers agree to perform the review, several additional requests to additional potential reviewers will often need to be sent by the editor to identify a sufficient number of confirmed reviewers for a particular document. Thus, this initial phase of conventional peer review alone tends to be unnecessarily long and time-consuming and produces only a small group of preselected qualified reviewers (i.e., 2-4) for each document.

Additionally, the contents of each review are typically assessed and combined with the results of other reviews received from the group of preselected reviewers for providing to the author. To avoid receiving an unmanageable volume of feedback for each document editors tend to limit the number of preselected reviewers assigned to review a particular document to a small group, such as 2-4 reviewers, which limits the breadth and sometimes the overall quality of the results of conventional peer review processes. Furthermore, not infrequently, for one reason or another (e.g., lack of time, loss of interest), one or more preselected reviewer fails to perform the review and provide the feedback within the requested timeframe or at all. This requires that the editor take one or more additional time-consuming actions including: spending time reminding underperforming or non-performing reviewers, extending the preferred deadline for completion of review, or contacting and selecting replacement reviewers which often also requires extending the review deadline. Thus, the small size of the group of preselected reviewers engaged in peer reviewing each document can present additional problems which further undesirably lengthen conventional peer review processes.

While email and other electronic communications have widened the pool of available qualified reviewers and shortened communication time amongst reviewers, authors and editors/approvers, there remains a need and desire to further increase the number of reviewers available for any particular document review and motivate reviewers to perform their reviews in a reasonable time frame.

Thus, there remains a need for peer review methods which are automated, randomized, have access to larger pools of qualified reviewers regardless of geographical location, and include boundaries on the time permitted for each phase of the peer review process while still providing useful peer reviews of high quality.

### SUMMARY OF THE INVENTION

The present invention relates to internet-based crowd peer review methods, and more particularly to internet-based methods for facilitating crowd peer review of authored documents, such as articles, reports, studies, and grant proposals, which are reviewed by pre-authorized reviewers and which may be revised by the authors based on such reviews prior to publication or acceptance. The crowd peer review method includes setting short deadlines for completion and submission of one or more reviews of the documents and completion of revisions to the document by the author(s). The deadlines are short but still reasonable due to the fact that the method is internet-based and, regardless of physical geographic location and time zone of the participants, the participants have ready access to the documents and related information and are able to provide reviews and revisions directly and quickly.

An internet-based crowd peer review method is provided which employs a user interface in communication through the internet with a peer review application which includes or is capable of accessing one or more proposed documents for review and a plurality of user records. Each user record identifies and corresponds to a unique user selected from an authorized editor, an author, and a pre-approved reviewer, and each user record includes identifying user criteria comprising at least: a user name, an anonymous alphanumeric label, one or more user types, and one or more technical fields or topics of expertise. The plurality of user records includes: (1) at least one editor record each of which corresponds to a unique identified authorized editor, wherein the user type includes authorized editor and, optionally, also includes pre-approved reviewer and the user name is an editor name; (2) at least one author record each of which corresponds to a unique identified author, wherein the user type includes author and, optionally, also includes pre-approved reviewer and the user name is an author name; and (3) at least twenty reviewer records each of which corresponds to a unique identified pre-approved reviewer, wherein the user type includes pre-approved reviewer and, optionally also either authorized editor or author and the user name is a reviewer name. The peer review application is capable of receiving and storing one or more reviewer comments associated with a selected proposed document, and is further capable of receiving, storing and applying criteria which governs storage and access to the proposed documents, and acceptance of, storage of, and access to the one or more reviewer comments.

In an exemplary embodiment, the internet-based crowd peer review method comprises the steps of: (A) selecting one of the one or more proposed documents for review; (B) selecting and storing, in the peer review application, author access criteria including an author list of one or more identified authors being granted permission to access the proposed document and instructions as to whether each listed author name may access the document prior to and after a review cutoff point, or only after the review cutoff point; (C) selecting and storing, in the peer review application, document access criteria for selecting, from the identified pre-approved reviewers, at least ten pre-approved reviewers being granted permission to access the selected proposed document and provide one or more review comments to the peer review application, wherein the document access criteria comprises at least one technical field or topic of expertise relevant to the selected proposed document. The method further comprises the steps of: (D) setting a review cutoff point by selecting and storing, in the peer review application, review cutoff criteria comprising one or more rules with which the peer review application determines the review cutoff point, wherein after the review cutoff point the peer review application will stop accepting review comments and the selected proposed document becomes a reviewed document; (E) notifying, or instructing the peer review application to notify, the at least ten pre-approved reviewers selected according to the document access criteria provided in step (C) that the selected proposed document is accessible for their review, that the peer review application will accept and store their review comments, and the review cutoff criteria selected in step (D); and (F) after the review cutoff point has been reached due to satisfaction of the review cutoff criteria provided in step (D), notifying, or instructing the peer review application to notify, each of the one or more identified authors selected according to the author access criteria provided in step (B) that stored review comments, or a report assembled by the peer review application based on stored review comments, are available for their review and consideration, wherein each of the steps (A)-(F) is performed by one or more of the identified editors through the user interface using the peer review application.

In some embodiments, after performance of the step of (E) notifying the at least ten pre-approved reviewers that the selected proposed document is accessible for their review and prior to reaching the review cutoff point, the peer review application receives and stores in the peer review application any review comments provided by any of the at least ten identified pre-approved reviewers selected according to the document access criteria provided in step (C) and the one or more review comments are associated with the selected proposed document and are accessible by each of the identified editors.

In some embodiments, the review cutoff criteria of step (D) comprise one or more of: (1) a due date or time period after which no additional reviewer comments will be received by the peer review application, (2) a maximum quantity of reviewer comments after which no additional reviewer comments will be received by the peer review application, and (3) a minimum or maximum quantity of reviewers allowed to submit reviewer comments after which no additional reviewer comments will be received by the peer review application. The review cutoff criteria of step (D) may comprise a due date or time period which is no more than 60 days after the day step (E) is performed to notify the at least ten pre-approved reviewers that the selected proposed document is accessible for their review. In some embodiments, the review cutoff criteria of step (D) comprise a due date or time period which is no more than 3 days after the day step (E) is performed.

In some embodiments, the document access criteria of step (C) further comprises one or more of: (1) a list of at least ten of the identified pre-approved reviewers, (2) a predetermined quantity of identified pre-approved reviewers, and (3) a percentage of all identified pre-approved reviewers.

In some embodiments, the internet-based crowd peer review method further comprises the step of providing instructions to the peer review application to allow access to review comments provided by any of the at least ten pre-approved reviewers selected according to the document access criteria provided in step (C) by one or more others of the at least ten pre-approved reviewers.

In some embodiments, the internet-based crowd peer review method further comprises the step of providing and storing, in the peer review application, review feedback criteria for instructing the peer review application to allow one or more of the at least ten pre-approved reviewers selected according to the document access criteria provided in step (C) to provide and feedback on the review comments of others of the at least ten pre-approved reviewers and to store such feedback in the peer review application.

In another exemplary embodiment, a system for enabling and managing an internet-based crowd peer review method comprises a memory and processor configured to perform the steps of: (A) accessing a plurality of user records each of which identifies and corresponds to a unique user selected from an authorized editor, an author, and a pre-approved reviewer, and includes identifying user criteria comprising at least: a user name, an anonymous alphanumeric label, one or more user types, and one or more technical fields or topics of expertise, wherein the plurality of user records includes: (1) at least one editor record each of which corresponds to a unique identified authorized editor, wherein the user type includes authorized editor and, optionally, also includes pre-approved reviewer and the user name is an editor name; (2) at least one author record each of which corresponds to a unique identified author, wherein the user type includes author and, optionally, also includes pre-approved reviewer and the user name is an author name; and (3) at least twenty reviewer records each of which corresponds to a unique identified pre-approved reviewer, wherein the user type includes pre-approved reviewer and, optionally also either authorized editor or author and the user name is a reviewer name. The method further comprises the steps of: (B) accessing one or more proposed documents and receiving selection of one of the proposed documents for review; (C) receiving and storing author access criteria including an author list of one or more identified authors and instructions as to whether each listed author name may access the document prior to and after a review cutoff point, or only after the review cutoff point; (D) allowing access to the selected proposed document by one or more of the identified authors which are selected by applying the author access criteria and instructions of step (C); (E) receiving and storing document access criteria comprising at least one technical field or topic of expertise; (F) selecting at least ten pre-approved reviewers from the identified pre-approved reviewers by applying the document access criteria of step (E) and granting each of the at least ten pre-approved reviewers access to the selected proposed document; (G) receiving from any of the at least ten pre-approved reviewers selected in step (F) one or more review comments on the selected proposed document and storing the one or more review comments for access by authorized users; (H) receiving and storing review cutoff criteria which is provided by an authorized editor and comprises one or more rules with which to determines the review cutoff point; (I) determining when the review cutoff point has been reached by applying the review cutoff criteria of step (H) and, after the review cutoff point is reached, stop receiving and storing review comments and relabel the selected proposed document as a reviewed document.

In some embodiments of the system for enabling and managing an internet-based crowd peer review method, the memory and processor are configured to also perform one or more of the following steps: (J) notifying the at least ten pre-approved reviewers selected in step (F) that the selected proposed document is accessible for their review, their review comments will be accepted and stored, and the review cutoff criteria received in step (H); (K) after the review cutoff point has been reached as determined in step (I), notifying each of the one or more identified authors selected according to the author access criteria provided in step (C) that stored review comments, or a report assembled by the peer review application based on stored review comments, are available for their review and consideration; or (L) receiving and storing, in the peer review application, performance feedback from users which relates to the performance of one or more pre-approved reviewers; accessing stored performance feedback; and producing a report or a performance rating, or both, for a pre-approved reviewer.

### BRIEF DESCRIPTION OF THE DRAWINGS

The present invention will be further explained with reference to the attached drawings. The drawings shown are not necessarily to scale, with emphasis instead generally being placed upon illustrating the principles of the present invention.

FIG. 1 is a schematic flow chart showing the steps of the present crowd peer review method and components involved therewith; and

FIG. 2 is a graphic timeline showing the time periods involved in the present crowd peer review method.

### DETAILED DESCRIPTION OF THE INVENTION

Detailed embodiments of the present invention are disclosed herein. It should be understood that the disclosed embodiments are merely illustrative of the invention which may be embodied in various forms. In addition, each of the examples given in connection with the various embodiments of the invention is intended to be illustrative, and not restrictive. Further, the figures are not necessarily to scale, and some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as examples for teaching one skilled in the art to variously employ the present invention.

The crowd peer review method described and contemplated herein includes setting short time frames (i.e., no more than about 60 days, such as about 3 days or less, or any length of time therebetween, but at least 6 hours) for completion and submission of one or more review comments on proposed documents (e.g., “review period”), such as without limitation articles, reports, studies, and grant proposals, as well as short time frames for completion and submission of a revised document by the author(s). The aforesaid time frames employed by the internet-based crowd peer review methods described herein are very short relative to conventional peer review processes which may take only several (4-6) weeks, but which typically take significantly longer than that, such as several months (on average, 4, 6, 8, or even more, months). Even current peer review methods which use computer networks, the interne, or cloud-based computing, to communicate electronically such as with email, chat boards, instant messaging platforms, or websites, and which do decrease the time required for the overall review and decision-making processes, have not developed or employed features which accelerate and streamline the completion and submission aspects of peer review to the degree accomplished by the crowd peer review method described and contemplated herein.

For example, the particularly short time frames for completing reviews that are enabled by the internet-based crowd peer review methods described herein are not generally acceptable or even possible with conventional peer review processes. One reason for this is the fact that the internet-based crowd peer review methods are internet-based and, regardless of physical geographic location and time zone of the participants, the participants have ready, immediate access to the documents and related information and are able to provide reviews and revisions directly and quickly. Additionally, the crowd peer review method described herein further accelerates the time required for completing document reviews even as compared to existing computer or internet aided peer review methods by making the documents under review instantly and simultaneously available to a large group of reviewers at one time. Another advantage over some conventional peer review methods is that the presently described method provides the ability to comment directly into a document, and to respond to others' comments in document.

Another reason why the present internet-based crowd peer review methods can be efficiently and successfully implemented much more quickly than previously possible without loss of quality, detail, usefulness, anonymity which minimizes bias, is the much larger pool of pre-approved reviewers that are assembled and engaged in the internet-based crowd peer review methods, i.e. at least ten and often up to 100 or more reviewers are notified and authorized to review a selected proposed document within a specified short time frame. This is a much larger pool of reviewers than in conventional peer review processes, where 2 to 4or 5 reviewers for any particular proposed document is the norm. Furthermore, with the present internet-based crowd peer review methods, minimal time is spent identifying qualified reviewers (i.e., only the time required to list several key words identifying the technical topic, subject matter or field with which the proposed document is concerned) and no time is needed to contact reviewers and gain agreement to participate in the peer review since notification of the availability of the proposed document to be reviewed is broadly issued to all qualified reviewers with participation agreement provided by actual performance of the review. Thus, neither the comparatively short time frames nor the very large pool of pre-approved reviewers are well-understood, routine, conventional features to those in the field of peer review of documents. In this respect, it is noted that some crowd based methods for obtaining reviews and comments on authored works, which may be practiced over the internet or other computing platforms and offer documents, or other authored content or work product, to the general public, or even on platforms accessed by alleged professionals or experts of various fields and technologies, typically sacrifice professional quality, reliability and accountability in return for any shortened time periods of the review process.

Even to the extent peer review has been increasingly automated or computer-implemented in recent years, those methods still tend to rely on the editor(s) individually selecting and contacting a select few potential reviewers with the result that a fairly small and limited number of reviewers is still employed for the review of any particular document. It is noted that contrary to general expectation, the internet-based crowd peer review methods contemplated and described herein surprisingly provide more comprehensive reviews and commentary than conventional peer review processes. Additionally, while open source literature, bulletin board, and crowd source types of forums have been enabled and popularized by internet and cloud computing in recent years, these tend to be open source platforms with unrestricted pools of participants, reviewers and commenters, which, in many cases, sacrifices quality, anonymity and reliability of the reviews and comments received. The present internet-based crowd peer review methods, on the other hand, employ screened, qualified and pre-approved reviewers who are members of a closed group or pool which, while quite large, is controlled and managed to maintain quality.

While the aforesaid internet-based peer review methods will be described in detail hereinafter as applied to the review, revision and publication of articles in scientific, medical or engineering periodicals, it is not limited to such use. Rather, persons of ordinary skill will recognize that these methods are advantageous for documents of a similar nature which describe or contain technical, mathematical, scientific, medical, engineering or even legal information, analysis and discussion. Such documents benefit from, gain credibility, and are often required to undergo peer review, comment and approval by reviewers having expertise in the relevant field prior to publication or approval. Documents to which these internet-based peer review methods are applicable include, without limitation, articles, reports, studies, thesis papers, law review articles, textbook chapters or sections, government and private grant proposals and written and video works of a creative nature.

Additionally, the peer review methods described herein are explained as being practiced with a user interface in communication over the internet with a peer review application and this is intended to include, but not be limited to, any and all arrangements in which the peer review application resides on a local or remote computing device (computer having memory and a processor, a server, a smart phone, a tablet, a television, a game console, etc.), or the cloud (e.g., delivery of hosted services over the internet), and is accessed by a user through a website, data entry interface or other portal application, over the internet with a local computing device or a terminal capable of communicating with such computing devices.

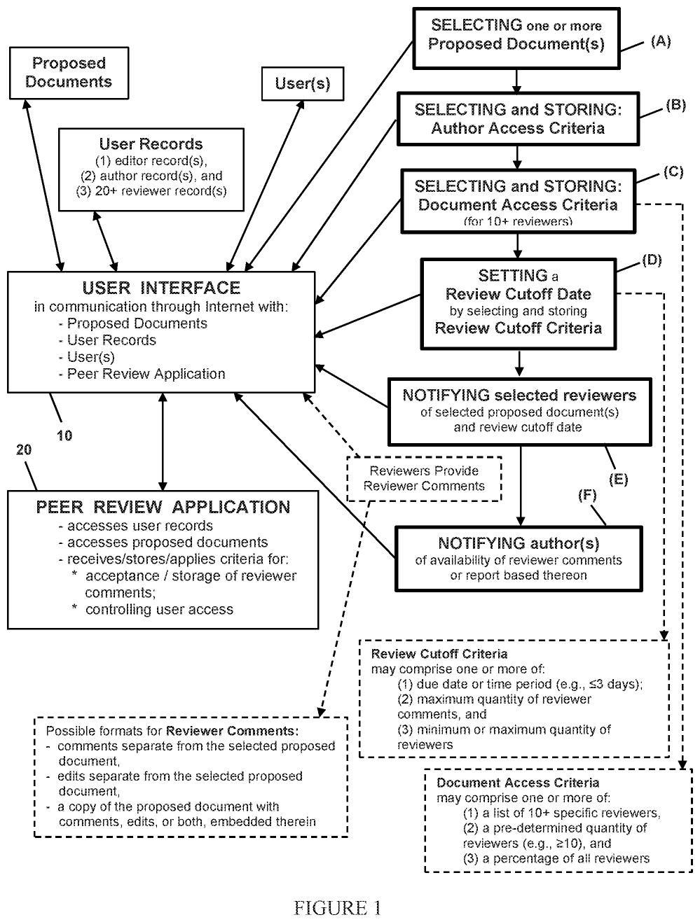

In one aspect of the present invention, and with reference to FIG. 1, a internet-based crowd peer review method is provided which employs a user interface 10 in communication through the internet with a peer review application 20 which includes or is capable of accessing one or more proposed documents for review, as well as a plurality of user records each of which identifies and corresponds to a unique user selected from an authorized editor, an author, and a pre-approved reviewer. One or more of the proposed documents and one or more of the user records, independently, may be stored in or by the peer review application 20, such as in the same readable memory device (now shown) as the peer review application 20 is stored or in a module thereof, or in or on a separate readable memory device (not shown), or even in or on a decentralized storage media such as the cloud, as long as the proposed documents and user records are accessible, through the interne, by the peer review application 20 and by one or more users.

Each user record includes identifying user criteria comprising at least: a user name, an anonymous alphanumeric label, one or more user types, and one or more technical fields or topics of expertise. The identifying user criteria for each editor record, author record, and reviewer record may also include one or more additional criteria selected from: location, contact information, title, educational credentials, professional credentials, employment history, publication history, and presentation history. Each of the plurality of user records is searchable according to one or more of the identifying user criteria, including at least the user name, the anonymous alphanumeric label, user type, and technical fields or topics of expertise. In some embodiments, the peer review application 20 is capable of searching each of the plurality of user records according to at least the aforesaid identifying user criteria.

The anonymous alphanumeric labels may be randomly generated and assigned to users and are useful to impart anonymity to users during the peer review process, yet also allow tracking of comments by and attributable to each reviewer providing review comments on a document. Anonymous alphanumeric labels (e.g., user-0001, user-0002, etc., or XX-100, XX-101, etc., among an infinite number of applicable possibilities) facilitates tracking how many reviewers are participating in the review of a particular proposed document and following discussions among multiple reviewers online, as well as tracking which reviewers are most active or which are inactive and should be removed from the peer review system, and for other purposes which will be apparent to persons of ordinary skill in the relevant art. In some embodiments, the anonymous alphanumeric label of one or more pre-approved reviewer is known to the identified editors, but not to other identified pre-approved reviewers.

The technical fields or topics of expertise are used to identify the subset of reviewers which are qualified to review a particular proposed document and, therefore, should be notified of the opportunity to review that proposed document. Accordingly, the more key words included for this identifying user criteria in each user record, the more useful, accurate and efficient the reviewer selection phase will be and the higher the quality and usefulness the results of the peer review will be. The technical fields or topics of expertise may, for example without limitation, be as broad and general as chemical engineering, physics, medicine, oncology, and mathematics, or more specific as dynamic process control, laser positioning, abdominal surgery, lung cancer, and mathematical modeling of ecological systems, or even very specific such as cyanide compound synthesis, laser diode module, laparoscopic hernia repair, mesothelioma, and isomorphic and homomorphic models.

The plurality of user records includes (1) at least one editor record, (2) at least one author record, and (3) at least twenty reviewer records. More particularly, each editor record corresponds to a unique identified authorized editor and the user type includes “authorized editor,” and may optionally also include “pre-approved reviewer.” The user name for each editor record is, of course, an editor name. Each author record corresponds to a unique identified author, and the user type includes “author” and, optionally, also includes “pre-approved reviewer.” The user name of each author record is an author name. To ensure the previously explained large pool of potential qualified and available reviewers, the plurality of user records available for use in the internet-based crowd peer review should include at least twenty reviewer records, each of which corresponds to a unique identified pre-approved reviewer. The user type for each reviewer record includes “pre-approved reviewer” and, optionally also either “authorized editor” or “author,” and the user name is a reviewer name.

The plurality of user records includes and identifies the entire pool of users of the internet-based crowd peer review method and system, and the users include one or more of an editor, an author, or a reviewer. Subsets of the entire pool of users (i.e., of the plurality of user records) are selected, depending at least in part on the particular document under consideration, and managed by one or more of the editors practicing the interne-based crowd peer review methods using the peer review application 20. All of the user records which include “pre-approved reviewer” as a user type collectively form the entire pool of potential reviewers which may be referred to as a Crowd Review Board. Similarly, all of the user records which include “editor” as a user type collectively form the entire pool of editors which may be referred to as an Editorial Board. Editors are typically in charge of managing the selection of documents for possible acceptance for publication, grant, etc. which then necessitates peer review before a final determination. It should be clear and understood to persons of ordinary skill in the relevant art that a particular user could be both an editor and a reviewer and, therefore, be a member of both the Crowd Review Board and the Editorial Board. Furthermore, a particular user may be an editor, a reviewer and an author, although when considering a given document undergoing peer review, an author of that given document would not be eligible to also participate as a reviewer of that given document. It should also clear that a particular user could be both an editor and an author, and such a user would not participate as an editor with respect to any document on which this user was an author.

In some larger organizations, there is an Editor-in-Chief who may receive manuscripts or proposed documents for consideration for acceptance, publication, grant, etc., make a first assessment of which of those submissions merits further consideration. The documents meriting further consideration as determined by the Editor-in-Chief are then often presented to the entire Editorial Board to select which documents will, for various reasons not relevant here, be subjected to closer scrutiny and peer review before a final determination as to whether to publish an article, authorize a research proposal, grant a monetary award, etc. It is at this point that a document would be subjected to peer review, such as by the internet-based crowd peer review methods described herein.

Since the benefits and improvements provided by the internet-based crowd peer review methods depend at least in part on having as many qualified reviewers as possible that can be invited to review any particular proposed document, the greater the quantity of reviewer records available to the peer review application 20, the better. This is because the greater the total quantity of potential reviewers available, the greater will be the quantity of appropriately qualified reviewers that can be invited to review a particular proposed document, and consequently, the better chance there is that a larger number of such qualified pre-approved reviewers will be interested and available to perform the peer review for that document. As explained above, the larger the number of reviews that are performed and the greater the quantity of review comments received for a particular proposed document, the more comprehensive, relevant and useful those comments will be to the authors and editors. Furthermore, since the peer review application 20 is employed in the internet-based crowd peer review methods to collect and assemble the comments into an organized report, the usual limitations of available time and effort to be contributed by the editors in conventional peer review processes do not apply and the benefits of the greater quantity of comments and feedback can be realized by the present crowd peer review methods. Accordingly, the plurality of user records available to the peer review application 20 should include at least 20 reviewer records, which consequently identifies at least 20 pre-approved reviewers to form the total pool of potential reviewers. For example, without limitation, the plurality of user records available to the peer review application 20 may include at least 50 reviewer records, or at least 80 reviewer records, or at least 100 reviewer records, or at least 150 reviewer records, or at least 200 reviewer records, or even more.

Generally, the peer review application 20 should be capable of receiving and storing one or more additional user records. The peer review application 20 is also capable of receiving and storing one or more reviewer comments associated with a selected proposed document. The peer review application 20 is also capable of receiving, storing and applying criteria which govern storage and access to the proposed documents, and acceptance of, storage of, and access to the one or more reviewer comments.

With reference again to FIG. 1, in one embodiment, the internet-based crowd peer review method comprises the steps of: (A) selecting one of the one or more proposed documents for review; (B) selecting and storing, in the peer review application 20, author access criteria including an author list of one or more identified authors being granted permission to access the proposed document and instructions as to whether each listed author name may access the document prior to and after a review cutoff point, or only after the review cutoff point. The author access criteria should be selected to result in inclusion of at least all authors of the particular selected proposed document being subjected to the crowd peer review. Thus, the author list should at least include the names of all the authors of the selected proposed document. Determination of appropriate author access criteria is within the ability of persons of ordinary skill in the relevant art.

As shown in FIG. 1, the internet-based crowd peer review method further comprises the step of (C) selecting and storing, in the peer review application 20, document access criteria for selecting, from the identified pre-approved reviewers, at least ten pre-approved reviewers being granted permission to access the selected proposed document and provide one or more review comments to the peer review application 20. In particular, the document access criteria should include at least one technical field or topic of expertise relevant to the selected proposed document. The document access criteria should be selected to include as many of the pre-approved reviewers in the pool (crowd) of potential reviewers to be notified of the review opportunity as are qualified to knowledgably and reliably opine on the subject matter of the particular proposed document under review as reasonably possible. Such document access criteria, of course, include as many technical fields or topics of expertise as possible key words for searching among the available reviewer records. Determination of appropriate document access criteria is within the ability of persons of ordinary skill in the relevant art. Generally, but not necessarily in any case, the at least ten of the identified pre-approved reviewers selected according to the document access criteria provided in step (C) does not include any of the one or more identified authors selected according to the criteria provided in step (B).

In some embodiments of the internet-based crowd peer review method, the document access criteria of step (C) further comprises one or more of: (1) a list of at least ten of the identified pre-approved reviewers, (2) a predetermined quantity of identified pre-approved reviewers, and (3) a percentage of all identified pre-approved reviewers. It is noted that where the document access criteria include a list of identified pre-approved reviewers, the minimum number of pre-approved reviewers on the list may be limited by the total quantity of reviewer records accessible by the peer review application 20. For example, if the total quantity of accessible reviewer records is 20, then the list cannot include greater than 20 pre-approved reviewers.

As shown in FIG. 1, the internet-based crowd peer review method further comprises the step of (D) setting a review cutoff point by selecting and storing, in the peer review application 20, review cutoff criteria. Review cut off criteria, for example without limitation, comprise one or more rules with which the peer review application 20 determines the review cutoff point, after which the peer review application 20 will stop accepting review comments and the selected proposed document becomes a reviewed document. As discussed above, the crowd peer review of the present invention allows a short time frame for completion of the review of the selection proposed document by the pool of qualified identified pre-approved reviewer, while facilitating a greater quantity of review comments and collaboration among reviewers for each proposed document selected for crowd peer review than was previously possible or understood in conventional or previous peer review processes.

In some embodiments, for example without limitation, the review cutoff criteria of step (D) comprises one or more of: (1) a due date or time period after which no additional reviewer comments will be received by the peer review application 20, (2) a maximum quantity of reviewer comments after which no additional reviewer comments will be received by the peer review application 20, and (3) a minimum or maximum quantity of reviewers allowed to submit reviewer comments after which no additional reviewer comments will be received by the peer review application 20. For example, to realize at least a portion of the benefits of the internet-based crowd peer review methods discussed above, in some embodiments, the due date or time period may be no more than 60 days after the day the notification step (E) is performed, which notifies the at least ten pre-approved reviewers that the selected proposed document is accessible for their review (thus beginning the review period for submission of review comments). For example without limitation, the due date or time period may be not more than 45 days, or no more than 30 days, or nor more than 20, or no more than 15 days, or no more than 10 days, or no more than 5 days, or not more than 4 days, or no more than 3 days, or no more than 2 days, or even no more than 1 day, after the day the notification step (E) is performed to notify the at least ten pre-approved reviewers. In some embodiments, the editor may also choose to cut off and stop accepting reviews if the editor determines, from the review comments received thus far, that the document under review cannot be accepted, published or otherwise cleared of the peer review process unless significant revisions are made. Such a determination is at the discretion, and well within the ability, of persons of ordinary skill in the relevant art, such as editors.

Generally, it is contemplated that one or more identified editors will perform each of steps (A)-(D) is performed by one or more of the identified editors through the user interface 10 using the peer review application 20. These steps essentially select the proposed document (step (A)) to be subjected to peer review according to the internet-based crowd peer review method and enable the peer review application 20 to identify the authors of that selected proposed document who should be involved in the peer review based on document by providing author access criteria (step (B)). Furthermore, these steps also enable the peer review application 20 to identify the pool of pre-approved reviewers best qualified to review the selected proposed document by providing document access criteria for selecting, from the entire pool of pre-approved reviewers, at least ten pre-approved reviewers (step (D)) who are qualified to review this particular selected proposed document. Selection of qualified reviewers is based at least in part any technical fields or topics of expertise common to a pre-approved reviewer and the selected proposed article.

With continued reference to FIG. 1, the internet-based crowd peer review method further comprises the steps of: (E) notifying, or instructing the peer review application 20 to notify, the at least ten pre-approved reviewers selected according to the document access criteria provided in step (C) that the selected proposed document is accessible for their review, that the peer review application 20 will accept and store their review comments, and the review cutoff criteria selected in step (D); and (F) after the review cutoff point has been reached due to satisfaction of the review cutoff criteria provided in step (D), notifying, or instructing the peer review application 20 to notify, each of the one or more identified authors selected according to the author access criteria provided in step (B) that stored review comments, or a report assembled by the peer review application 20 based on stored review comments, are available for their review and consideration. Either or both of these notification steps (E) and (F) may be performed directly by one or more of the identified editors, using email or another electronic communication method (e.g., via a social media platform), without the involvement or assistance of the peer review application 20. In some embodiments the peer review application 20 is further capable of performing one or both of notification steps (E) and (F) and in such embodiments, it would be equally acceptable and effective, and likely more efficient and faster, to instruct the peer review application 20 to perform either or both of these notification steps (E) and (F), again such as by email or other electronic communication method (e.g., via a social media platform).

After performance of the step of (E) notifying the at least ten pre-approved reviewers that the selected proposed document is accessible for their review and prior to reaching the review cutoff point, the peer review application 20 receives and stores in the peer review application 20 any review comments provided by any of the at least ten identified pre-approved reviewers selected according to the document access criteria provided in step (C) and the one or more review comments are associated with the selected proposed document and are accessible by each of the identified editors. In some embodiments, the present internet-based crowd peer review method further comprises the step (not shown in FIG. 1) of selecting and storing, in the peer review application 20, review commencement criteria comprising one or more rules which dictate when the peer review application 20 will begin accepting reviews from the pre-authorized reviewers selected based on the document access criteria provided in step (C). The review comments provided by any of the at least ten identified pre-approved reviewers selected according to the document access criteria provided in step (C) are written and in one or more formats selected from: comments separate from but associated with the selected proposed document, edits separate from the selected proposed document, and a copy of the selected proposed document with comments, edits, or both, embedded therein. As discussed above, the internet-based crowd peer review methods described herein enable the setting of a particularly short (e.g., from about 6 hours to about 60 days) review period within which selected pre-approved reviewers will be able to review and provide reviewer comments for any given selected proposed document. This feature is exists not only because the presently described internet-based crowd peer review methods utilize the internet and computer technologies and devices, but also because the total pool of pre-approved reviewers, which is drawn from to identify selected reviewers, is very large (at least about 20, such as at least 100) compared to existing peer review methods. Consequently, the quantity of potential pre-approved reviewers (i.e., from among those in the total pool of reviewers) which are qualified to review a selected proposed document and who will be contacted and offered the opportunity to review the selected proposed document, is greater than the quantity of reviewers (i.e., 2-5) typically contacted during existing peer review methods. It is noted that the total pool of pre-approved reviewers is a closed group of reviewers, the qualifications and experience of each of which has been reviewed by editors and possibly others, as appropriate, to ensure their ability and willingness to participate in the present internet-based crowd peer review methods, while maintaining the quality of the reviewer comments obtained during the document review period. This large number of potential, qualified, pre-approved reviewers guarantees a sufficient number of responses in a short time, which in turn, enables the setting of the significantly shortened review period (e.g., from about 6 hours to about 60 days) of the present peer review methods.

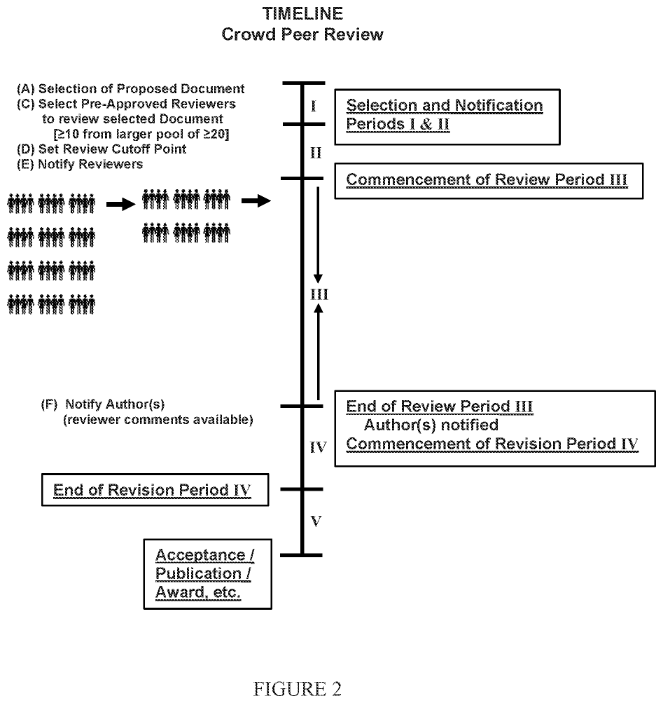

The foregoing novel and advantageous aspects of the presently described internet-based crown peer review method are shown graphically by a timeline shown in FIG. 2 and which starts with Selection and Notification Periods I and II, during which method steps (A)-(E) described above are typically performed. Briefly, these steps involve (A) selecting the proposed document for review, (C) qualified reviewers from the total pool of reviewers, (D) setting a review cut off period, and notifying the selected reviewers that they are invited to review the proposed document and the due date (cutoff point) for completing and submitting their reviewer comments. As will be recognized by persons of ordinary skill in the relevant art, steps (A)-(E) are generally within the control of the ultimate decision-makers, such as editors. Accordingly, these steps can be shortened or lengthened as determined by such decision-makers to balance efficiency and quality as necessary in any given context.

With reference still to FIG. 2, the next period is the Review Period III during which reviewers perform their review of the selected proposed document and provide their reviewer comments for consideration by the decision-makers (e.g., editors) and author(s). As a practical matter, the length of time required for the Review Period III is almost out of the decision-makers' control and tends to be unnecessarily lengthened at least in part because the decision-makers are typically at the mercy of a very few particular reviewers who were specifically contacted and agreed to perform the peer reviews. The larger quantity of qualified, pre-approved reviewers provided by the internet-based crowd peer review methods nearly ensures that a sufficient number of qualified reviewers will be available and able to complete the their reviews within the shortened Review Period III set by the selected review cutoff point. Applicants have found that, performing the internet-based crowd review methods, Review Periods III of as short as about one month, or about 7 days, or even about 3 days, has, in practice, provided a sufficient quantity of peer reviews (and, therefore, of reviewer comments) to enable authors to make meaningful and sufficient revisions to their proposed documents, and enable editors to make acceptance and publishing decisions on proposed documents with confidence in the quality of the reviews and the published documents. These Review Periods III are significantly shorter, and likely not reasonably possible, by conventional peer review methods, even those practiced using computer, internet and email technologies. The comparatively short time frames for the Review Period III are, in part, enabled by the very large, but closed, pool of pre-approved reviewers, and each of these features is not well-understood, routine, conventional features to those in the field of peer review of documents. The end of the Review Period III is followed by a Revision Period IV, as shown in FIG. 2. During the Revision Period IV, the author(s) of a selected proposed document which has been the subject of reviewer comments, are able to review those reviewer comments (or receive a report or summary of those comments from the editors, or peer review application 20) and make revisions to their document. The revised document can then be reviewed and reconsidered by the editors during a subsequent Decision Period V, or even subjected to an additional round of peer review using the internet-based crowd peer review methods described herein. As will be recognized by persons of ordinary skill in the relevant art, the length of the Revision Period IV can be at least somewhat controlled or influenced by the decision-makers by setting a deadline for receipt of the revised proposed document, after which the author will not have his or her document published, or otherwise accepted for release, or grant award, etc., as the case may be. This provides incentive for authors to provide revised documents within Revision Periods IV of reasonable predetermined lengths of time. Additionally, it is fairly clear that the Decision Period is nearly entirely within the control of the decision-makers (e.g., editors).

In some cases, it may be desirable or beneficial to allow the pre-approved reviewers to see one another's review comments during the review period, and even to comment on each other's comments. Thus, in some embodiments, the internet-based crowd peer review method further comprises the step of providing instructions to the peer review application 20 to allow access to review comments provided by any of the at least ten pre-approved reviewers selected according to the document access criteria provided in step (C) by one or more others of the at least ten pre-approved reviewers. In further embodiments, the method may further comprise the step of providing and storing, in the peer review application 20, review feedback criteria for instructing the peer review application 20 to allow one or more of the at least ten pre-approved reviewers selected according to the document access criteria provided in step (C) to provide feedback on the review comments of others of the at least ten pre-approved reviewers and to store such feedback in the peer review application 20.

It may be useful in some cases to provide a ranking system for the reviewers, editors and even authors to provide an indication of the relevance or usefulness of one or more of the review comments. Accordingly, in some embodiments, the internet-based crowd peer review method further comprises the steps of: providing, in the peer review application 20, a standardized rating scale for use by identified pre-approved reviewers to comment on the comments and reviews of other identified pre-approved reviewer, instructing the identified pre-approved reviewers to provide feedback using the standardized rating scale, and receiving and storing, in the peer review application 20, the feedback using the standardized rating scale. For example, without limitation, the standardized rating scale may be as follows:

“1”=issue raised by review not important at all,

“2”=issue raised by review is perhaps interesting or useful, but not critical,

“3”=addressing issue raised by review will improve quality of the document,

“4”=issue raised by review important and should be addressed by the author(s);

“5”=issue raised by review is critical and must be addressed by the authors prior to acceptance and publication.

Separately, it may also be useful in some cases for the method to include collecting information and feedback relating to the performance of the pre-approved reviewers and calculating or otherwise reporting a rating for each pre-approved reviewer. Accordingly, in some embodiments, the internet-based crowd peer review method may further comprise one or more of the following steps: receiving and storing, in the peer review application 20, performance feedback from users, including but not limited to one or more of an editor, a pre-approved reviewer and an author, where the performance feedback relates to the performance of one or more pre-approved reviewers; instructing or inviting users to provide performance feedback; accessing stored performance feedback; and producing a report, or a performance rating, or both, for a pre-approved reviewer. For example, without limitation, performance feedback may be based on or relate to one or more of the following factors:

1) how often, in a pre-determined time frame, a pre-approved reviewer comments or reviews proposed documents;

2) how many proposed documents a pre-approved reviewer reviews in a pre-determined time frame, or since becoming a pre-approved reviewer;

3) how many comments a pre-approved reviewer provides in each review performed and provided;

4) how quickly after a proposed document is posted a pre-approved reviewer provides comments or reviews; and

5) feedback or ratings for a pre-approved reviewer that other users provide.

The peer review application 20 may also be capable of collecting and assembling the review comments which are directed to a reviewed proposed document to produce an organized consolidated review report. Where a standardized rating scale is applied to rank at least a portion of the review comments, the consolidated report may include the scale values with the comments, or may even organize the report based at least in part on the scale values. Such a report may facilitate the author(s) review and consideration of the review comments.

Often the author(s) of a proposed document that has undergone peer review (regardless of the method followed) will consider the review comments and feedback and revise the document to improve and resubmit it for reconsideration by the editor(s), particularly if the editor(s) rejected or dismissed the proposed document after peer review. Thus, the internet-based crowd peer review method may further comprise the step of setting a revision due date by selecting and storing, in the peer review application 20, revision deadline criteria comprising one or more rules with which the peer review application 20 determines the revision due date, after which the peer review application 20 will no longer accept a revised document from any of the one or more authors on the author list and the reviewed document becomes a final document. In such embodiments, the method may also comprise the step of notifying, after the review cutoff point, the one or more identified authors on the author list provided in step (B) that the review cutoff point has been reached and of the revision due date. Optionally, the method may optionally comprise the step of notifying, after the revision due date, the one or more authors on the author list the revision due date has passed.

For various reasons, it may be desirable to allow outside persons who are not otherwise involved in the crowd peer review method to access and view the review comments submitted by one or more of the identified pre-approved reviewers, and optionally to even provide their own outside comments and feedback. Accordingly, the internet-based crowd peer review method may permit outside persons not identified by any editor record, author record or reviewer record to view one or more of the selected proposed document, the reviewed document, and the review comments, without permission to edit or comment. Additionally, the method may further allow such outside persons to also provide outside comments which are received and stored by the peer review application 20.

In another aspect, a system for enabling and managing an internet-based crowd peer review method is provided which comprises a memory and processor configured to perform at least the following steps:

(A) accessing a plurality of user records each of which identifies and corresponds to a unique user selected from an authorized editor, an author, and a pre-approved reviewer, and includes identifying user criteria comprising at least: a user name, an anonymous alphanumeric label, one or more user types, and one or more technical fields or topics of expertise, wherein the plurality of user records includes:

(1) at least one editor record each of which corresponds to a unique identified authorized editor, wherein the user type includes authorized editor and, optionally, also includes pre-approved reviewer and the user name is an editor name;

(2) at least one author record each of which corresponds to a unique identified author, wherein the user type includes author and, optionally, also includes pre-approved reviewer and the user name is an author name; and

(3) at least twenty reviewer records each of which corresponds to a unique identified pre-approved reviewer, wherein the user type includes pre-approved reviewer and, optionally also either authorized editor or author and the user name is a reviewer name;

(B) accessing one or more proposed documents and receiving selection of one of the proposed documents for review;
(C) receiving and storing author access criteria including an author list of one or more identified authors and instructions as to whether each listed author name may access the document prior to and after a review cutoff point, or only after the review cutoff point;
(D) allowing access to the selected proposed document by one or more of the identified authors which are selected by applying the author access criteria and instructions of step (C);
(E) receiving and storing document access criteria comprising at least one technical field or topic of expertise;
(F) selecting at least ten pre-approved reviewers from the identified pre-approved reviewers by applying the document access criteria of step (E) and granting each of the at least ten pre-approved reviewers access to the selected proposed document;
(G) receiving from any of the at least ten pre-approved reviewers selected in step (F) one or more review comments on the selected proposed document and storing the one or more review comments for access by authorized users;
(H) receiving and storing review cutoff criteria which is provided by an authorized editor and comprises one or more rules with which to determines the review cutoff point
(I) determining when the review cutoff point has been reached by applying the review cutoff criteria of step (H) and, after the review cutoff point is reached, stop receiving and storing review comments and relabel the selected proposed document as a reviewed document;
(J) optionally, notifying the at least ten pre-approved reviewers selected in step (F) that the selected proposed document is accessible for their review, their review comments will be accepted and stored, and the review cutoff criteria received in step (H); and
(K) optionally, after the review cutoff point has been reached as determined in step (I), notifying each of the one or more identified authors selected according to the author access criteria provided in step (C) that stored review comments, or a report assembled by the peer review application 20 based on stored review comments, are available for their review and consideration.
As will be readily recognized and understood by persons of ordinary skill in the relevant art, the various features and optional embodiments discussed above in connection with the internet-based crowd peer review methods also apply to the system for enabling and managing an internet-based crowd peer review method and such variations and embodiments of the system are contemplated and intended to be included herein.

It will be understood that the embodiments of the present invention described hereinabove are merely exemplary and that a person skilled in the art may make variations and modifications without departing from the spirit and scope of the invention. All such variations and modifications are intended to be included within the scope of the present invention.

1. An internet-based crowd peer review method which employs a user interface in communication through the internet with a peer review application which includes or is capable of accessing one or more proposed documents for review and a plurality of user records each of which identifies and corresponds to a unique user selected from an authorized editor, an author, and a pre-approved reviewer, and includes identifying user criteria comprising at least: a user name, an anonymous alphanumeric label, one or more user types, and one or more technical fields or topics of expertise, wherein the plurality of user records includes:
(1) at least one editor record each of which corresponds to a unique identified authorized editor, wherein the user type includes authorized editor and, optionally, also includes pre-approved reviewer and the user name is an editor name;
(2) at least one author record each of which corresponds to a unique identified author, wherein the user type includes author and, optionally, also includes pre-approved reviewer and the user name is an author name; and
(3) at least twenty reviewer records each of which corresponds to a unique identified pre-approved reviewer, wherein the user type includes pre-approved reviewer and, optionally also either authorized editor or author and the user name is a reviewer name;
wherein the peer review application is capable of receiving and storing one or more reviewer comments associated with a selected proposed document,
and wherein the peer review application is further capable of receiving, storing and applying criteria which governs storage and access to the proposed documents, and acceptance of, storage of, and access to the one or more reviewer comments, said method comprising the steps of:
(A) selecting one of the one or more proposed documents for review;
(B) selecting and storing, in the peer review application, author access criteria including an author list of one or more identified authors being granted permission to access the proposed document and instructions as to whether each listed author name may access the document prior to and after a review cutoff point, or only after the review cutoff point;
(C) selecting and storing, in the peer review application, document access criteria for selecting, from the identified pre-approved reviewers, at least ten pre-approved reviewers being granted permission to access the selected proposed document and provide one or more review comments to the peer review application, wherein the document access criteria comprises at least one technical field or topic of expertise relevant to the selected proposed document;
(D) setting a review cutoff point by selecting and storing, in the peer review application, review cutoff criteria comprising one or more rules with which the peer review application determines the review cutoff point, wherein after the review cutoff point the peer review application will stop accepting review comments and the selected proposed document becomes a reviewed document;
(E) notifying, or instructing the peer review application to notify, the at least ten pre-approved reviewers selected according to the document access criteria provided in step (C) that the selected proposed document is accessible for their review, that the peer review application will accept and store their review comments, and the review cutoff criteria selected in step (D); and
(F) after the review cutoff point has been reached due to satisfaction of the review cutoff criteria provided in step (D), notifying, or instructing the peer review application to notify, each of the one or more identified authors selected according to the author access criteria provided in step (B) that stored review comments, or a report assembled by the peer review application based on stored review comments, are available for their review and consideration,
wherein each of the steps (A)-(F) is performed by one or more of the identified editors through the user interface using the peer review application.

2. The internet-based crowd peer review method of claim 1, wherein, after performance of the step of (E) notifying the at least ten pre-approved reviewers that the selected proposed document is accessible for their review and prior to reaching the review cutoff point, the peer review application receives and stores in the peer review application any review comments provided by any of the at least ten identified pre-approved reviewers selected according to the document access criteria provided in step (C) and the one or more review comments are associated with the selected proposed document and are accessible by each of the identified editors.

3. The internet-based crowd peer review method of claim 1, wherein the review cutoff criteria of step (D) comprise one or more of: (1) a due date or time period after which no additional reviewer comments will be received by the peer review application, (2) a maximum quantity of reviewer comments to be accepted, after which no additional reviewer comments will be received by the peer review application, (3) a minimum or maximum quantity of reviewers allowed to submit reviewer comments after which no additional reviewer comments will be received by the peer review application.

4. The internet-based crowd peer review method of claim 3, wherein the review cutoff criteria of step (D) comprises a due date or time period which is no more than 60 days after the day step (E) is performed to notify the at least ten pre-approved reviewers that the selected proposed document is accessible for their review.

5. The internet-based crowd peer review method of claim 3, wherein the review cutoff criteria of step (D) comprises a due date or time period which is no more than 3 days after the day step (E) is performed.

6. The internet-based crowd peer review method of claim 1, wherein the document access criteria of step (C) further comprises one or more of: (1) a list of at least ten of the identified pre-approved reviewers, (2) a predetermined quantity of identified pre-approved reviewers, and (3) a percentage of all identified pre-approved reviewers.

7. The internet-based crowd peer review method of claim 1, wherein the at least ten of the identified pre-approved reviewers selected according to the document access criteria provided in step (C) does not include any of the one or more identified authors selected according to the criteria provided in step (B).

8. The internet-based crowd peer review method of claim 1, further comprising the step of selecting and storing, in the peer review application, review commencement criteria comprising one or more rules which dictate when the peer review application will begin accepting reviews from the pre-authorized reviewers selected based on the document access criteria provided in step (C).

9. The internet-based crowd peer review method of claim 1, wherein the review comments provided by any of the at least ten identified pre-approved reviewers selected according to the document access criteria provided in step (C) are written and in one or more formats selected from: comments separate from but associated with the selected proposed document, edits separate from the selected proposed document, and a copy of the selected proposed document with comments, edit, or both, embedded therein.

10. The internet-based crowd peer review method of claim 1, further comprising the step of providing instructions to the peer review application to allow access to review comments provided by any of the at least ten pre-approved reviewers selected according to the document access criteria provided in step (C) by one or more others of the at least ten pre-approved reviewers.

11. The internet-based crowd peer review method of claim 10, further comprising the step of providing and storing, in the peer review application, review feedback criteria for instructing the peer review application to allow one or more of the at least ten pre-approved reviewers selected according to the document access criteria provided in step (C) to provide and feedback on the review comments of others of the at least ten pre-approved reviewers and to store such feedback in the peer review application.

12. The internet-based crowd peer review method of claim 1, wherein the anonymous alphanumeric label of a pre-approved reviewer is known to the identified editors, but not to other identified pre-approved reviewers.

13. The internet-based crowd peer review method of claim 1, wherein the peer review application is further capable of receiving and storing one or more additional user records.

14. The internet-based crowd peer review method of claim 1, further comprising the step of providing and storing, in the peer review application, a standardized rating scale for use by identified pre-approved reviewers to comment on the reviews of other identified pre-approved reviewer and instructing the identified pre-approved reviewers to provide feedback using the standardized rating scale.

15. The internet-based crowd peer review method of claim 14, wherein the standardized rating scale applied by an identified pre-approved reviewer to a review of another identified pre-approved reviewer is as follows:
“1”=issue raised by review not important at all,
“2”=issue raised by review is perhaps interesting or useful, but not critical,
“3”=addressing issue raised by review will improve quality of the document,
“4”=issue raised by review important and should be addressed by the author(s);
“5”=issue raised by review is critical and must be addressed by the authors prior to acceptance and publication.

16. The internet-based crowd peer review method of claim 1, wherein each editor record, author record, and reviewer record further include one or more identifying user criteria selected from: location, contact information, title, educational credentials, professional credentials, employment history, publication history, and presentation history.

17. The internet-based crowd peer review method of claim 1, further comprising the step of setting a revision due date by selecting and storing, in the peer review application, revision deadline criteria comprising one or more rules with which the peer review application determines the revision due date, after which the peer review application will no longer accept a revised document from any of the one or more authors on the author list and the reviewed document becomes a final document.

18. The internet-based crowd peer review method of claim 17, further comprising the step of notifying, after the review cutoff point, the one or more identified authors on the author list provided in step (B) that the review cutoff point has been reached and of the revision due date.

19. The internet-based crowd peer review method of claim 17, further comprising the step of notifying, after the revision due date, the one or more authors on the author list the revision due date has passed.

20. The internet-based crowd peer review method of claim 1, wherein persons not identified by any editor record, author record or reviewer record are permitted to view one or more of the selected proposed document, the reviewed document, and the review comments, without permission to edit or comment.

21. The internet-based crowd peer review method of claim 20, wherein the persons not identified by any editor record, author record or reviewer record are permitted to provide outside comments which are received and stored by the peer review application.

22. A system for enabling and managing an internet-based crowd peer review method comprising a memory and processor configured to perform the steps of:
(A) accessing a plurality of user records each of which identifies and corresponds to a unique user selected from an authorized editor, an author, and a pre-approved reviewer, and includes identifying user criteria comprising at least: a user name, an anonymous alphanumeric label, one or more user types, and one or more technical fields or topics of expertise, wherein the plurality of user records includes:
(1) at least one editor record each of which corresponds to a unique identified authorized editor, wherein the user type includes authorized editor and, optionally, also includes pre-approved reviewer and the user name is an editor name;
(2) at least one author record each of which corresponds to a unique identified author, wherein the user type includes author and, optionally, also includes pre-approved reviewer and the user name is an author name; and
(3) at least twenty reviewer records each of which corresponds to a unique identified pre-approved reviewer, wherein the user type includes pre-approved reviewer and, optionally also either authorized editor or author and the user name is a reviewer name;
(B) accessing one or more proposed documents and receiving selection of one of the proposed documents for review;
(C) receiving and storing author access criteria including an author list of one or more identified authors and instructions as to whether each listed author name may access the document prior to and after a review cutoff point, or only after the review cutoff point;
(D) allowing access to the selected proposed document by one or more of the identified authors which are selected by applying the author access criteria and instructions of step (C);
(E) receiving and storing document access criteria comprising at least one technical field or topic of expertise;
(F) selecting at least ten pre-approved reviewers from the identified pre-approved reviewers by applying the document access criteria of step (E) and granting each of the at least ten pre-approved reviewers access to the selected proposed document;
(G) receiving from any of the at least ten pre-approved reviewers selected in step (F) one or more review comments on the selected proposed document and storing the one or more review comments for access by authorized users;
(H) receiving and storing review cutoff criteria which is provided by an authorized editor and comprises one or more rules with which to determines the review cutoff point;
(I) determining when the review cutoff point has been reached by applying the review cutoff criteria of step (H) and, after the review cutoff point is reached, stop receiving and storing review comments and relabel the selected proposed document as a reviewed document;
(J) optionally, notifying the at least ten pre-approved reviewers selected in step (F) that the selected proposed document is accessible for their review, their review comments will be accepted and stored, and the review cutoff criteria received in step (H);
(K) optionally, after the review cutoff point has been reached as determined in step (I), notifying each of the one or more identified authors selected according to the author access criteria provided in step (C) that stored review comments, or a report assembled by the peer review application based on stored review comments, are available for their review and consideration; and
(L) optionally, receiving and storing, in the peer review application, performance feedback from users which relates to the performance of one or more pre-approved reviewers; accessing stored performance feedback; and producing a report or a performance rating, or both, for a pre-approved reviewer.
